(19) United States
(12) Patent Application Publication
(10) Pub. No.: US 2008/0042623 A1
(43) Pub. Date: Feb. 21, 2008

(54) Recharging system for low-voltage, cordless appliances

(76) Inventor: Anthony Kit Lun Leung, North Point (HK)

Correspondence Address: Lawrence Cruz;Conair Corporation, One Cummings Point Road, STAMFORD, CT, 06902, US

(21) Appl. No.: 11/891,099

(22) Filed: Aug. 9, 2007

Related U.S. Application Data
(60) Provisional application No. 60/838,744, filed on Aug. 18, 2006.

(51) Int. Cl. H02J 7/04

(52) U.S. Cl. 320/165

(57) ABSTRACT

An appliance charger comprises an electrical cord (6) for connection to an electrical source, a transformer (2), a control circuit board (4) or chip, contact terminals (7) for contacting an appliance (8), and a switch (5) for selectively closing a circuit when an appliance is connected to the charger and for opening the circuit by default when the appliance is removed, thereby cutting off power to the transformer.

### CROSS-REFERENCE TO RELATED APPLICATIONS

This application claims priority from U.S. Provisional Application 60/838,744, filed Aug. 18, 2006.

### BACKGROUND OF THE INVENTION

1. Field of the Invention

The present invention relates to cordless appliances and, more particularly, to cordless rechargeable appliances having low-voltage such that a transformer is required.

2. Description of Related Art

Various known cordless rechargeable appliances exist for various uses. Typical low-voltage appliances that require the use of a transformer have a charging base that remains plugged into a wall socket or other source of external electrical energy. The base is available for the appliance to be inserted or removed, selectively, for charging. Even while the appliance is not inserted for charging, electrical current is drawn through the base and energy is being consumed.

It is desirable to provide a charging base or system for an appliance that does not constantly draw electrical energy while the charging base or system is not in use charging an appliance in order to reduce electricity costs.

### OBJECTS OF THE PRESENT INVENTION

It is an object of the present invention to provide an appliance charging system that does not constantly draw electrical energy while the charging base or system is not in use charging an appliance.

These and other objects are achieved by the present invention.

### BRIEF SUMMARY OF THE PRESENT INVENTION

According to the present invention, an appliance charger comprises an electrical cord for connection to an electrical source, a transformer, a control circuit board or chip, contact terminals for contacting an appliance, and a switch for selectively closing a circuit when an appliance is connected to the charger and for opening the circuit by default when the appliance is removed, thereby cutting off power to the transformer.

### BRIEF DESCRIPTION OF THE ILLUSTRATION FIGURES

FIG. 1 is a schematic of a first preferred embodiment of the present invention.

FIG. 2 is a schematic of a second preferred embodiment of the present invention.

FIGS. 3A-3B are schematics of a third preferred embodiment of the present invention.

### DETAILED DESCRIPTION OF THE PREFERRED EMBODIMENT OF THE INVENTION

While the present invention is described herein with respect to particular types of appliances by way of example, the present invention is directed to the charging system and is not limited to specific appliance types.

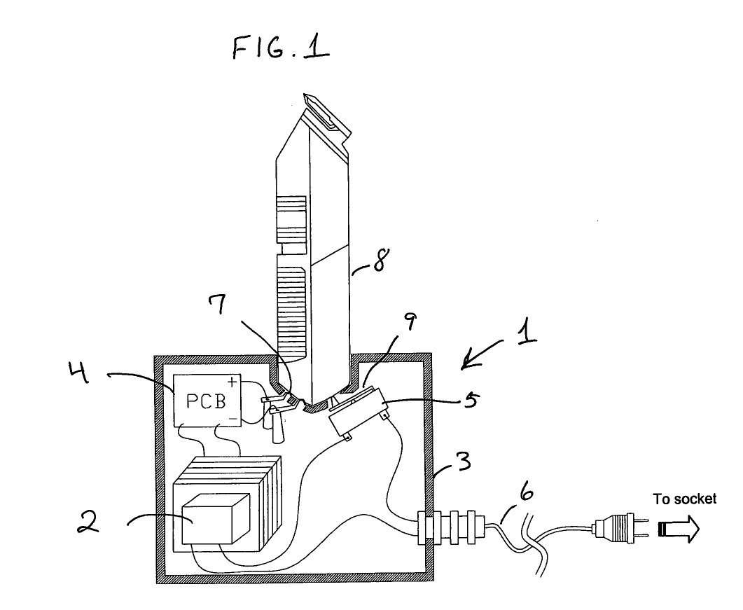

Referring to FIG. 1, a charging system (1) can be in the form of a base (3) that is shaped to rest on a generally flat surface and to house the following internal components: a transformer (2) of a conventional type, a circuit board (4) or chip for controlling functions, and a switch (5) for selectively closing or opening an electrical circuit. An external cord (6) extends from said base (3) to plug into an external power source. A set of contacts (7) are positioned to electrically charge an appliance, such as a hair clipper (8) or any other appliance, positioned in the base (3). A switch mechanism (9) is activated by placement of the appliance into the base and de-activated by its removal such that in the activated position, a circuit is formed so that electrical current is supplied which charges the appliance, which is equipped with conventional rechargeable means such as batteries. When the appliance is removed and the switch mechanism (9) is de-activated, the circuit is opened and, thus, no current is drawn. It is conceivable that instead of contacts as shown, any one of a variety of electrically conductive connections can be used including a plug or plurality of plug elements.

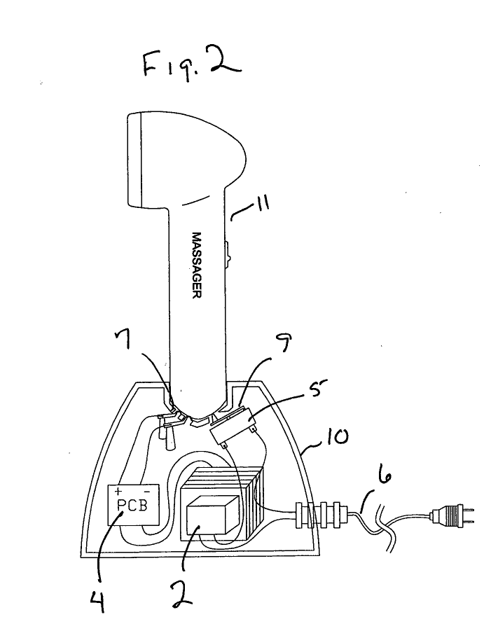

FIG. 2 shows another shape for the base (10) and a different type of appliance, a hand held massager (11). Components that are otherwise similar to those shown in the embodiment of FIG. 1 are similarly labeled.

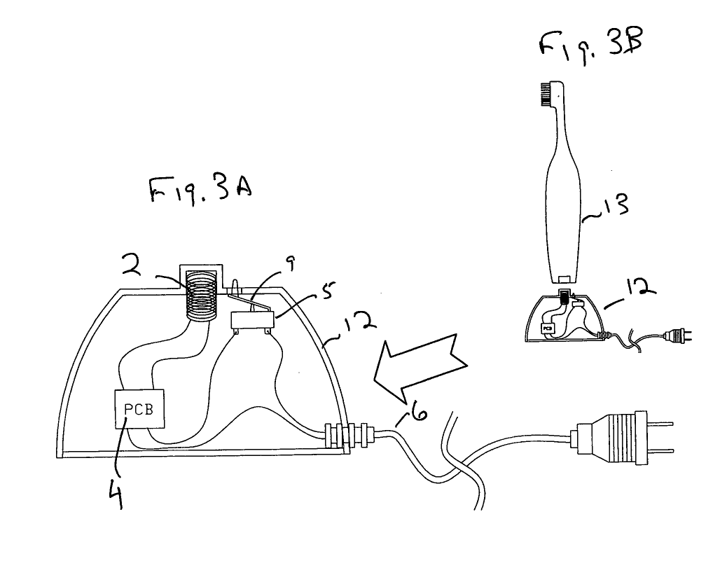

FIGS. 3A and 3B show another shape for the base (12) and a different type of appliance, an electric toothbrush (13). Components that are otherwise similar to those shown in the embodiment of FIG. 1 are similarly labeled.

What is claimed is:

1. A recharging base for a rechargeable electric appliance, said base comprising
a housing;
an electrical cord extending from said housing and having one end adapted to plug into an external electrical source for supplying electrical energy to said base;
at least one electrical contact surface exposed externally of said housing for transferring electrical energy from said external electrical source to a rechargeable battery that is placed in electrically conductive contact with said contact surface; and
a switch associated with said contact surface for selectively enabling or disabling transfer of electrical energy to said contact surface.

2. A base according to claim 1, further comprising
a receptacle on said housing for receiving an appliance containing said battery and maintaining said battery in electrically conductive contact with said contact surface.

3. A base according to claim 1, further comprising
an actuating mechanism associated with said switch for selectively enabling and disabling said switch when said mechanism is contacted by said battery or a structure connected to said battery.

4. A base according to claim 2, further comprising
an actuating mechanism associated with said switch for selectively enabling and disabling said switch when said mechanism is contacted by said appliance.

5. A base according to claim 1, further comprising
an electrical transformer located in said housing.

6. A base according to claim 1, further comprising
a control circuit board located in said housing for controlling one or more functions of said base.

7. A base according to claim 1, wherein
said switch is moveable between a first position in which said switch completes a closed electric circuit and draws electrical power from said external electrical source, and a second position in which said switch opens said closed electric circuit so that no electrical power is drawn from said external electrical source.
